(19) United States
(12) Patent Application Publication
(10) Pub. No.: US 2009/0283615 A1
(43) Pub. Date: Nov. 19, 2009

(54) Nozzle With Improved Close-In Water Distribution

(75) Inventor: Samuel C. Walker, Green Valley, AZ (US)

Correspondence Address: FITCH EVEN TABIN & FLANNERY, 120 SOUTH LASALLE STREET, SUITE 1600, CHICAGO, IL, 60603-3406, US

(73) Assignee: RAIN BIRD CORPORATION, Azusa, CA (US)

(21) Appl. No.: 12/120,607

(22) Filed: May 14, 2008

(51) Int. Cl. B05B 1/14; B05B 1/26

(52) U.S. Cl. 239/590; 239/518

(57) ABSTRACT

A nozzle is provided having a primary outlet for distribution of water relatively distant from the nozzle and a secondary outlet for distribution of water relatively close to the nozzle. The nozzle includes a threaded portion for coupling the nozzle to a source of pressurized water. A flow channel to the secondary outlet is formed through the threads to provide an appropriate pressure drop to improve water distribution to terrain relatively close to the nozzle. The flow channel may cut across the threads or may extend in the same direction as the threads. The flow channel may be tortuous or non-tortuous based on the number of directional changes in the flow channel, thereby allowing the tailoring of close-in water distribution characteristics.

### FIELD OF THE INVENTION

This invention relates to irrigation sprinklers and, more particularly, to a sprinkler having a spray head nozzle for improved irrigation relatively close to the nozzle.

### BACKGROUND OF THE INVENTION

A common type of irrigation sprinkler is one having a spray head nozzle that produces a fan-shaped spray. These nozzles are often designed to distribute water in a specific arcuate pattern about the nozzle, such as quarter, half, three-quarters, or full-circle nozzle configurations that distribute water in 90°, 180°, 270°, or 360° arcs, respectively, about the nozzle. Such spray heads are frequently mounted on either a stationary riser, or a pop-up riser that is mounted in a housing buried in the ground. With respect to a pop-up riser, the riser generally is retracted into the housing when the sprinkler is not in use and moves vertically upwards and above the ground when the sprinkler is in use.

One desirable feature of such spray head nozzles is a matched precipitation rate, such that the rate of water distribution is the same regardless of the specific arcuate nozzle configuration. In other words, it is desirable to have quarter, half, three-quarters, full-circle, and other nozzle configurations that distribute proportional volumes of water. For example, it is desirable to design a series of spray head nozzles where the half-circle nozzle distributes twice the volume of water that a quarter-circle nozzle would per unit of time, given the same supply pressure. Accordingly, it is desirable to have spray head nozzles in which different arcuate nozzle configurations operate to distribute the same volume of water per unit area and unit time.

One significant shortcoming of sprinklers having spray head nozzles is the difference in water distribution for terrain relatively close to the sprinkler compared to water distribution to terrain relatively distant from the sprinkler. More specifically, sprinklers having spray head nozzles frequently fail to provide sufficient water close to the sprinkler itself. Often, such sprinklers provide little, if any, water to the terrain immediately adjacent the sprinkler and extending radially outwardly a given distance from the sprinkler.

One attempt to address this problem has been to provide a number of sprinklers spaced close together to compensate for any dry areas near each sprinkler. This solution, however, is not optimal. It results in increased cost based on the use of superfluous sprinklers and also may lead to uneven and wasteful water distribution with certain areas receiving more water than desired.

Another attempt to address insufficient close-in water distribution has been through the use of a spray nozzle having two outlets: a primary outlet for watering relatively distant terrain and a secondary outlet for close-in watering. This solution has produced mixed results. In some conventional spray head nozzles, water is distributed from the secondary outlet at too high a pressure and velocity, thereby providing little additional water to the terrain close to the sprinkler. Also, in many conventional sprinklers, the secondary outlet (and/or the flow channels leading to the secondary outlet) must be relatively small in size to distribute water close to the sprinkler, resulting in the frequent clogging of the secondary outlet and/or flow channels with grit or other particles.

Accordingly, there is a need for a spray head nozzle that distributes water to terrain relatively close to the nozzle. Also, it is desirable that the nozzle be usable to achieve a matched precipitation rate for different arcuate nozzle configurations. Further, there is a need for a spray head nozzle that is less susceptible to clogging by particulate matter in the water and that allows such particulate matter to be easily cleaned from the nozzle.

### BRIEF DESCRIPTION OF THE DRAWINGS

FIG. 1 is a perspective view of a first embodiment of a spray head nozzle mounted to a riser and embodying features of the present invention;

FIG. 2 is a cross-sectional view of the spray head nozzle of FIG. 1;

FIG. 3 is a top exploded perspective view of the spray head nozzle and riser of FIG. 1;

FIG. 4 is a bottom exploded perspective view of the spray head nozzle and riser of FIG. 1;

FIG. 5 is a perspective view of a deflector for the spray head nozzle of FIG. 1 where the deflector is a quarter-circle deflector;

FIG. 6 is a perspective view of a deflector for the spray head nozzle of FIG. 1 where the deflector is a half-circle deflector;

FIG. 7 is a perspective view of a nozzle body for the spray nozzle of FIG. 1 having a non-tortuous flow channel;

FIG. 8 is a perspective view of a nozzle body for the spray nozzle of FIG. 1 having a tortuous flow channel;

FIG. 9 is a top perspective view of a throttling screw seat for the spray head nozzle of FIG. 1;

FIG. 10 is a bottom perspective view of a throttling screw seat for the spray head nozzle of FIG. 1;

FIG. 11 is a cross-sectional view of an alternate embodiment of a spray head nozzle mounted to a riser and embodying features of the present invention;

FIG. 12 is an exploded partial perspective view of the spray head nozzle and riser of FIG. 11;

FIG. 13 is a top perspective view of a nozzle body for the spray nozzle of FIG. 11;

FIG. 14 is a bottom perspective view of a nozzle body for the spray nozzle of FIG. 11 having a non-tortuous flow channel;

FIG. 15 is a bottom perspective view of a nozzle body for the spray nozzle of FIG. 11 having a tortuous flow channel; and

FIG. 16 is a perspective view of a filter for the spray nozzle of FIG. 11.

### DESCRIPTION OF THE PREFERRED EMBODIMENTS

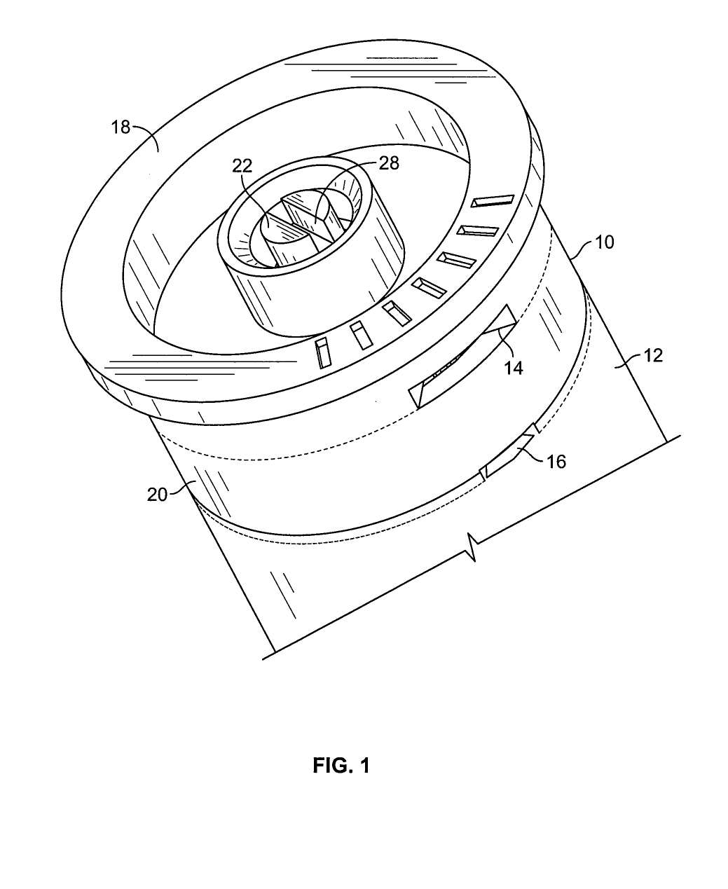

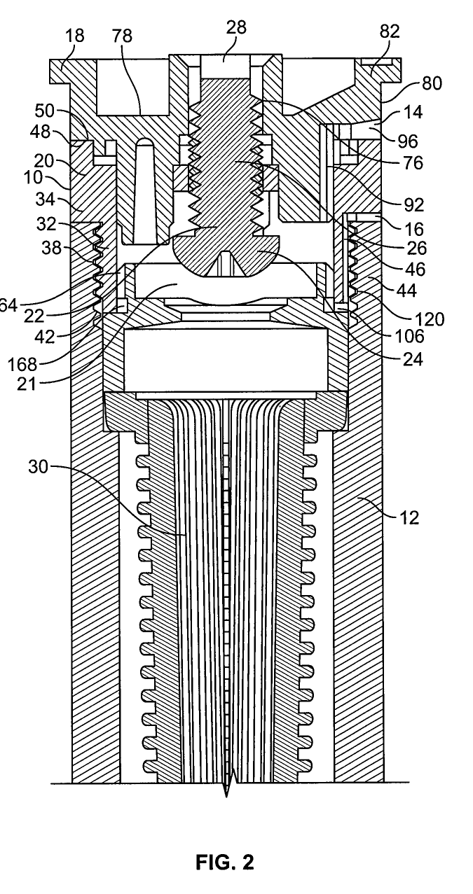

With reference to FIGS. 1 and 2, a first preferred embodiment of a spray head nozzle 10 mounted to a riser is shown that provides enhanced water distribution to terrain relatively close to the nozzle 10. The spray head nozzle 10 represents a modification over conventional nozzles mounted to a riser and having two outlets, i.e., a primary outlet for distant water distribution and a secondary outlet for close-in water distribution. One such type of conventional nozzle is disclosed in U.S. Pat. No. 5,642,861, which is assigned to the assignee of the present invention and which is incorporated herein by reference in its entirety.

As described further below, the spray head nozzle 10 includes, among other things, a flow channel that is molded into and among the threads of the nozzle 10. The molding of this flow channel in this manner provides several significant advantages. The use of a flow channel among the threads allows for a pressure drop resulting in improved close-in watering of terrain. The amount of the pressure drop depends on the exact course of the flow channel through the threads, which may be modified for different models of nozzle 10. This molding also allows the flow channel to be relatively large in cross-sectional diameter, which limits the amount of clogging by grit. Further, the flow channel may be cleaned of grit relatively easily by simply unscrewing the nozzle from the riser and rinsing the threads.

As can be seen in FIGS. 1 and 2, the nozzle 10 is adapted for thread-on mounting onto the upper end of a stationary or pop-up tubular riser 12, which serves as a source of pressurized water. During operation, the spray head nozzle 10 distributes water in two discrete water streams. More specifically, water is distributed from a primary outlet 14 in a primary water stream at a relatively high velocity and pressure, resulting in the irrigation of area relatively distant from the nozzle 10. Water also is distributed from a secondary outlet 16 in a secondary water stream at a relatively low velocity and pressure, resulting in the irrigation of area relatively close to the nozzle 10.

The nozzle 10 preferably includes a deflector 18, a nozzle body 20, a throttling screw seat 21, and a throttling screw 22. As can be seen in FIGS. 1 and 2, the deflector 18 engages the nozzle body 20 to form the primary outlet 14, and the nozzle body 20 engages the riser 12 to form the secondary outlet 16. The deflector, nozzle body, and throttling screw seat components are preferably formed of a molded plastic material, or other suitable material, and are described in greater detail below.

The throttling screw 22 includes a head 24, a shank 26, and a slotted end 28. The slotted end 28 may be adjusted by a screwdriver, or other hand tool, to move the head 24 of the throttling screw 22 closer toward or further away from a filter 30 and the incoming water stream. The throw distance is reduced as the head 24 is moved closer to the filter 30, and it is increased by moving it in the opposite direction.

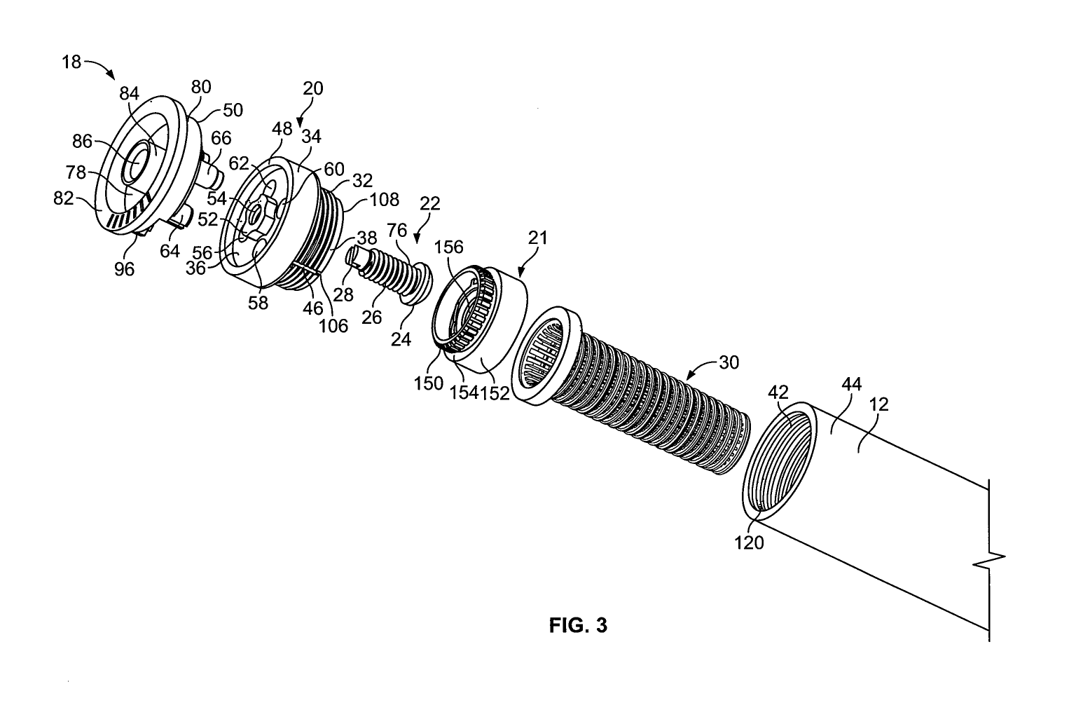

As shown in FIGS. 3, 4, 7, and 8 the nozzle body 20 is comprised generally of a lower hollow cylindrical portion 32 and an upper hollow cylindrical portion 34 that are joined at a center plate 36. The lower portion 32 extends downwardly from the center plate 36 and has external, or male, threads 38 formed about its exterior surface. These external threads 38 are adapted for engagement with corresponding internal, or female, threads 42 formed around the inside of the upper end 44 of the riser 12. These external threads 38 also define a flow channel 46 through the threads 38, as described in greater detail below.

The upper cylindrical portion 34 extends upwardly from the center plate 36. It has a slightly greater diameter than the lower portion 32 and substantially the same inner diameter as the center plate 36. The upper annular edge 48 of the upper cylindrical portion 34 is adapted for abutting engagement with the underside surface 50 of the deflector 18, as described further below.

As can be seen in FIG. 3, the center plate 36 preferably includes a plurality of apertures extending therethrough and an upwardly projecting center hub 52 defining a central bore 54. There are preferably four apertures 56, 58, 60, and 62 that are dimensioned to accommodate the insertion of a like number of posts 64, 66, 68, and 70 protruding downwardly from the underside surface 50 of the deflector 18. The four apertures 56, 58, 60, and 62 are preferably equidistantly spaced about the center plate 36 and situated at the same radius from the central axis of the nozzle body 20. The upwardly projecting hub 52 defines a central bore 54 through the center plate 36 to accommodate the insertion of the adjustable throttling screw 22. The internal surface of the hub 52 is formed with threads which are adapted to engage external threads 76 formed about the shank 26 of the throttling screw 22.

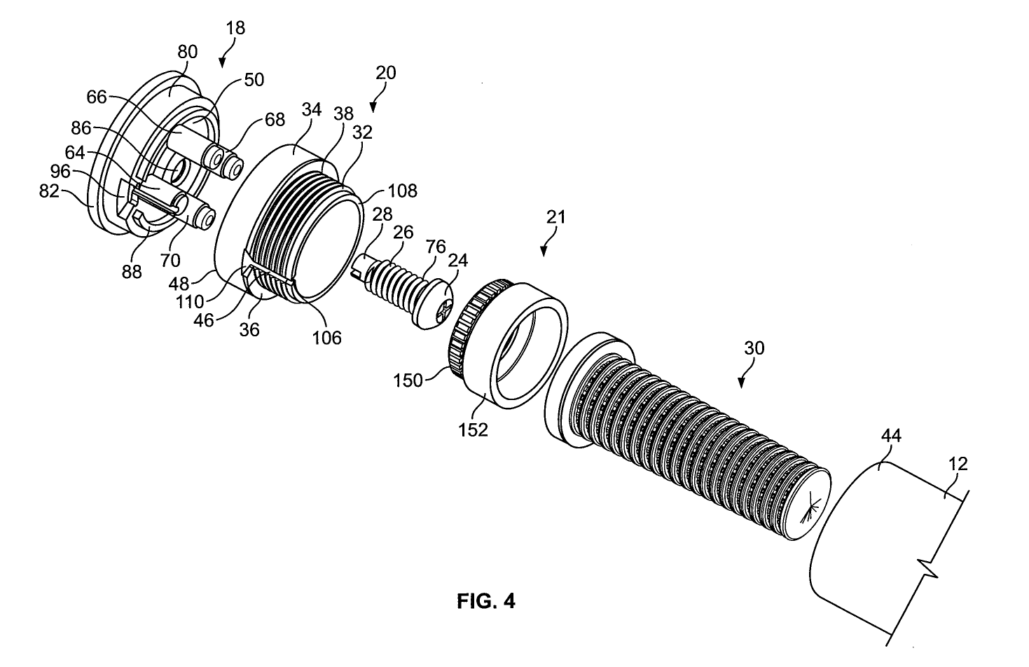

As shown in FIGS. 3 and 4, the deflector 18 overlies the nozzle body 20 with the underside surface 50 of the deflector 18 engaging the upper edge 48 of the nozzle body 20. The deflector 18 preferably includes a base plate 78, a vertical cylindrical wall portion 80 having an outer surface diameter substantially the same as that of the outer surface diameter of the upper cylindrical portion 34, the generally horizontal underside surface 50, and a radially enlarged peripheral flange portion 82 projecting outwardly around the upper end of the wall portion 80. A hub 84 is formed centrally in the deflector 18 and extends upwardly from the base plate 78. The deflector hub 84 defines a central bore 86, which is dimensioned to permit the slotted end 28 of the throttling screw 22 to project therethrough for adjustment thereof. The nozzle body and deflector bores 54 and 86 are preferably in a concentric relationship when the deflector 18 is mounted to the nozzle body 20.

As shown in FIGS. 4-6, each of the posts 64, 66, 68, and 70 projects downwardly from the underside surface 50 of the base plate 78 of the deflector 18 to engage one of the apertures 56, 58, 60, and 62 in the center plate 36 of the nozzle body 20. The posts 64, 66, 68, and 70 are preferably cylindrical in shape and equidistantly spaced, and each is preferably situated about the same radius from the central axis of the deflector 18. The posts 64, 66, 68, and 70 are dimensioned and positioned to engage with the apertures 56, 58, 60, and 62 in the center plate 36 of the nozzle body 20 and serve to mount the deflector 18 to the nozzle body 20. Insertion of the posts 64, 66, 68, and 70 through the apertures 56, 58, 60, and 62 limits rotational movement of the nozzle body 20 relative to the deflector 18.

The deflector 18 also includes other features, in addition to the posts 64, 66, 68, and 70, to improve mounting of the deflector 18 to the nozzle body 20. An arcuate rib 88 extends downwardly from the underside surface 50 of the base plate 78 of the deflector 18. The rib 88 engages the upper annular edge 48 of the nozzle body 20 along the interior circumference of the upper edge 48 to minimize lateral movement of the nozzle body 20 relative to the deflector 18. In addition, the deflector hub 84 preferably extends downwardly from the underside surface 50 of the base plate 78 to engage the upwardly projecting nozzle body hub 52, again to minimize lateral movement of the nozzle body 20 relative to the deflector 18. The deflector 18 and nozzle body 20 may be bonded together in accordance with conventional fastening methods, preferably by welding.

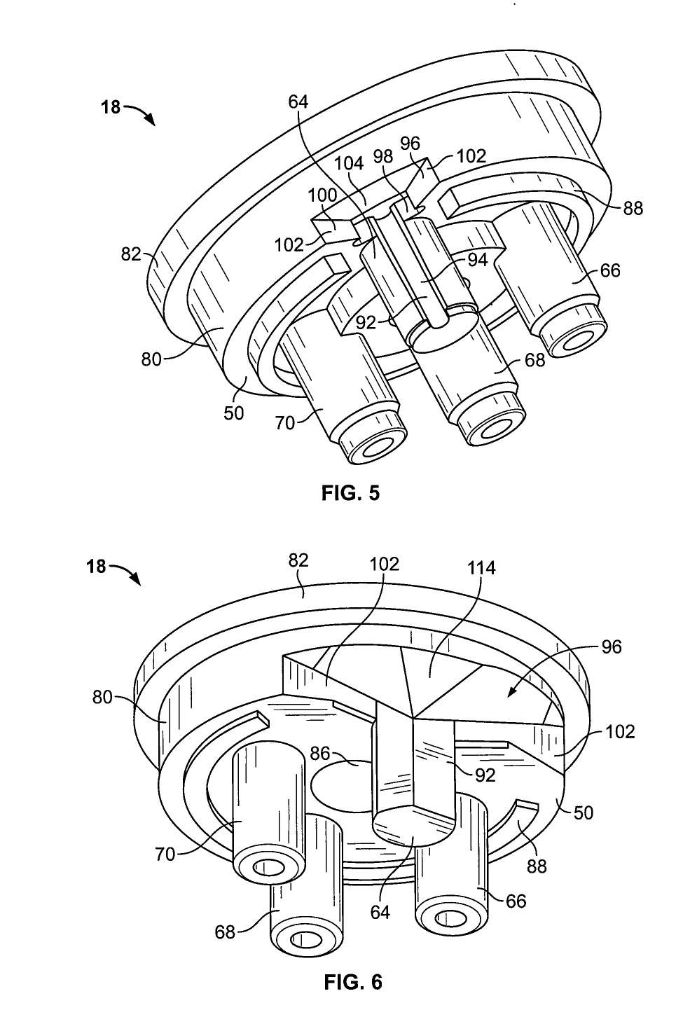

The deflector 18 also is formed to provide a flow passage 92 to the primary outlet 14 for relatively distant water distribution. More specifically, as shown in FIGS. 5 and 6, one of the posts 64 includes a slot 94 extending along the length of the post 64, which defines the flow passage 92. The slot 94 terminates in a substantially wedge-shaped recess 96 formed in the wall portion 80 and the underside surface 50 of the base plate 78 of the deflector 18. The slot 94 may be in any number of shapes as long as it provides a flow passage 92 for water extending along the length of the post 64. In one form, as shown in FIG. 5, the recess 96 has an inner substantially T-shaped portion 98 that expands radially outwardly into an outer fan-shaped portion 100. The outer portion 100 is formed of two opposing sidewalls 102 and a top wall 104. The exact shape of the recess 96 can be modified as desired to address design variables, such as precipitation rate and desired water distribution pattern. For example, in FIG. 5, the recess 96 is shaped for quarter-circle distribution, while in FIG. 6, the recess 96 is shaped for half-circle distribution.

The primary outlet 14 is formed by the engagement of the deflector 18 with the nozzle body 20. More specifically, the top edge of the primary outlet 14 is formed by the top wall 104, the sides of the primary outlet 14 are formed by the two opposing sidewalls 102, and the bottom of the primary outlet 14 is formed by the upper annular edge 48 of the nozzle body 20. The slot 94 and deflector recess 96 may be sized and shaped in various ways such that the volume of water that flows therethrough is regulated for different models to achieve a matched precipitation rate through the primary outlet 14. For example, the deflector recess 96 of one nozzle 10 may be shaped for quarter-circle water distribution, as shown in FIG. 5, and the slot 94 sized to achieve a desired precipitation rate. In turn, the deflector recess 96 of a second nozzle 10 may be shaped for half-circle water distribution, as shown in FIG. 6, with the cross-sectional size of the slot 94 increased (relative to that for the quarter-circle nozzle) to allow an additional volume of water to flow therethrough to match the precipitation rate of the quarter-circle nozzle.

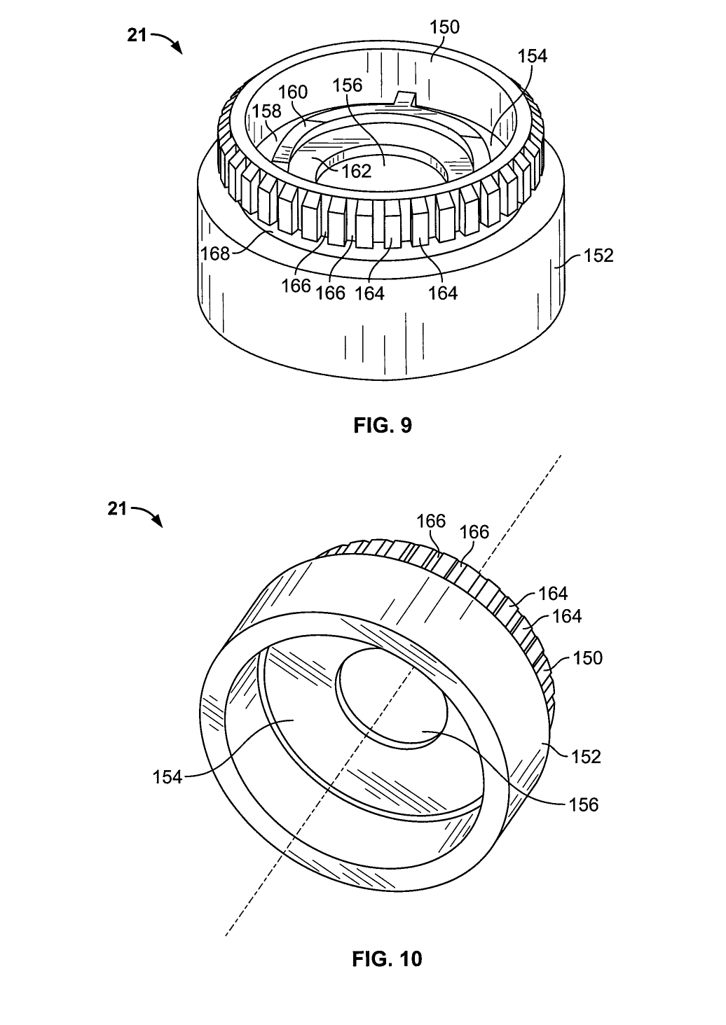

As shown in FIGS. 9 and 10, in one form, the nozzle 10 also includes a throttling screw seat 21. The throttling screw seat 21 preferably includes an upper cylindrical portion 150, a lower cylindrical portion 152, and an annular flange portion 154. The cylindrical portions 150 and 152 are oriented such that they define the same central axis. The radius of the upper portion 150 is sized such that it can be slidably inserted within the lower threaded portion 32 of the nozzle body 20. The lower portions 32 and 152 of the nozzle body 20 and throttling screw seat 21, respectively, have substantially the same radius such that, when the throttling screw seat 21 is slidably inserted into the nozzle body 20, the lower portions 32 and 152 abut one another.

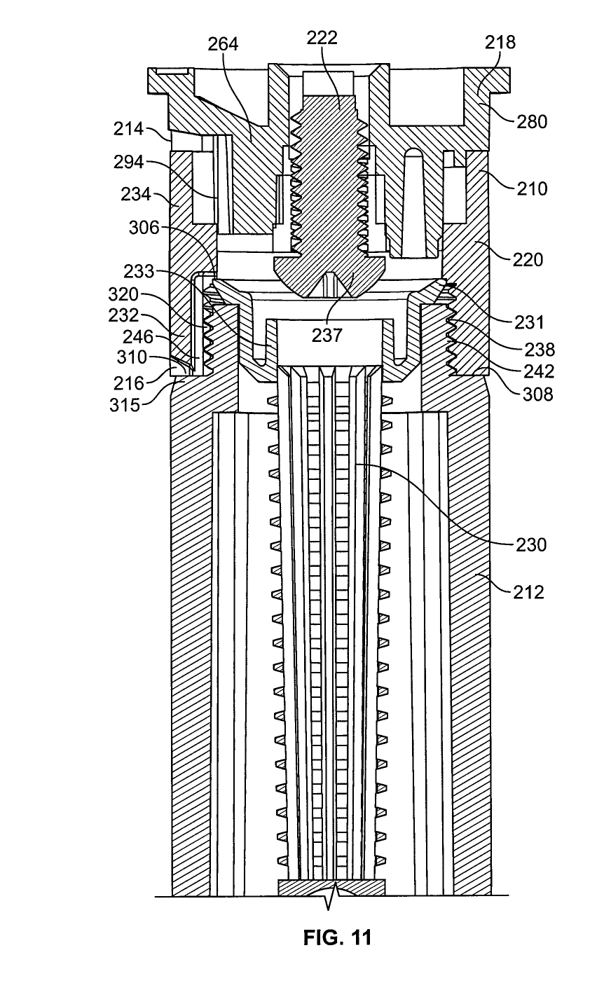

The throttling screw seat 21 also preferably includes an annular portion 154 defining a central bore 156 therethrough. The top surface 158 of the annular portion 154 has a circular rib 160 that varies in height about its circumference, and the rib 160 and bore 156 define an inner flange portion 162 therebetween. The top surface 158 is shaped to act as a seat for the throttling screw 22 when the screw 22 is fully advanced toward the seat 21 to reduce the throw distance of the nozzle 10 to a shut-off condition. Use of this throttling screw seat 21 allows the use of a filter 30 having a relatively large diameter (such as compared to that shown in FIGS. 11 and 16).

As can be seen in FIGS. 3, 4, and 9, the upper cylindrical portion 150 preferably includes a series of circumferentially spaced fingers 164 that define circumferentially spaced axial notches 166 therebetween. The fingers 164 and axial notches 166 alternate sequentially about the outside of the upper cylindrical portion 150 and extend in a radially outward and an axial direction along the top portion of the upper cylindrical portion 150. A circumferential collection groove 168 is defined between the bottom edges of the fingers 164 and the annular portion 154 when the seat 21 is mounted to the nozzle body 20. In the form shown in FIG. 9, the seat 21 preferably includes 36 axial notches. When the throttling screw seat 21 is mounted to the nozzle body 20, the axial notches 166 define flow conduits to guide the flow of water from the inside of the seat 21 downwardly to collection groove 168, as described further below.

As shown in FIG. 2, the nozzle body 20 is formed to provide access to a flow channel 46 to a secondary outlet 16 for close-in water distribution. More specifically, the nozzle body 20 has a radial notch 106 formed in its lower edge 108, and this radial notch 106 acts as an entrance to the flow channel 46 to the secondary outlet 16. By creating a number of axial notches 166 (FIG. 9) in the throttling screw seat 21, the specific orientation of the nozzle body 20 relative to the seat 21 is not significant. A single axial notch in the nozzle body 20 could be designed to be placed in fluid communication with the radial notch 106, but this would require a specific rotational orientation of the nozzle body 20 relative to the seat 21. In addition, the use of multiple, circumferentially spaced axial notches 166 serves to filter water flowing towards the secondary outlet 16. As a result, the filter 30 may be designed to be of a size appropriate for filtering water flowing towards the primary outlet 14.

During operation, water flows upwardly through the riser 12, through the filter 30, and through the bore 156 of the throttling screw seat 21, and then flows downwardly through the axial notches 166 and into the collection groove 168. Water then flows through the radial notch 106 formed in the lower edge 108 of the nozzle body 20. It then enters the flow channel 46 formed in the external threads 38 of the nozzle body 20, and the flow channel 46 terminates in a recess 110 formed on the exterior of the nozzle body 20. The cross-sectional size of the flow channel 46 is small in size relative to that of the slot 94 in the deflector 18, resulting in close-in water distribution. The nozzle body recess 110 is preferably wedge-shaped with side walls 112 and a top wall 114 and is formed on the exterior lower surface of the center plate 36. The recess 110 may be any of various shapes to achieve the desired water distribution pattern, such as quarter-circle or half-circle water distribution, but preferably corresponds to the arcuate shape of the deflector recess 96.

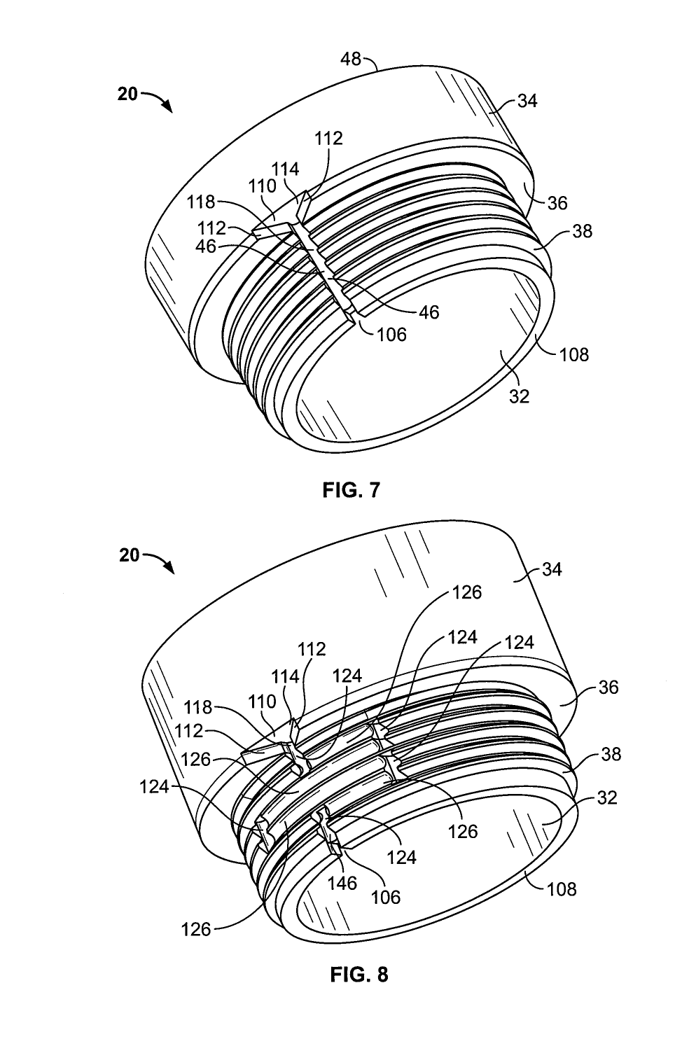

With reference to FIGS. 2 and 7, the secondary outlet 16 is formed by the engagement of the nozzle body 20 with the riser 12. More specifically, the top edge of the secondary outlet 16 is formed by top wall 114, the sides of the secondary outlet 16 are formed by the sidewalls 112, and the bottom edge of the secondary outlet 16 is formed by the upper end 44 of the riser 12. The nozzle body recess 110 and the deflector recess 96 are preferably sized and positioned in coordination such that the primary and secondary outlets 14 and 16 distribute water radially outward in the same general arcuate direction from the nozzle 10.

As can be seen from FIGS. 7 and 8, the exact path of the flow channel 46 and 146 among the threads 38 may be modified to achieve desired water distribution characteristics for close-in watering. For example, in one form, as shown in FIG. 7, the channel 46 extends generally parallel to the axis in a unidirectional line, cutting across the threads 38 in a direction perpendicular to the threads 38. Energy and velocity in water flowing along this channel 46 towards the secondary outlet 16 is dissipated. Water exiting the secondary outlet is distributed closer to the nozzle 10 than water exiting the primary outlet 14.

The use of this flow channel 46 achieves a pressure drop by creating a series of orifice openings between the wall 118 of the flow channel 46 in the nozzle body 20 and the threaded portion of the riser 12. The cross-sections of these orifices alternate in size corresponding to the alternation in riser threads 42 and riser grooves 120. Narrow orifices are defined by riser threads 42 that project towards the flow channel wall 118. In contrast, wide orifices are defined by riser grooves 120 that are relatively distant from the flow channel wall 118.

It is known that orifices can be used in series to reduce the pressure and velocity of water flow. Orifices used in series achieve a greater reduction in pressure and velocity than would be achieved through the use of a single orifice of uniform cross-section. Thus, the series of orifice openings in the flow channel 46 acts to reduce pressure. Further, when there are a number of orifices in series, the relative size of the openings created can be relatively large in comparison to single orifice passageways required to achieve comparable pressure drops in conventional sprinklers. In other words, to achieve the same pressure and velocity drop, a single orifice would have to be very small in size. A benefit of a series of relatively larger orifices is the use of a larger channel size which reduces the chance of clogging by grit. Further, any particulate matter that does become lodged in the flow channel 46 may be easily cleaned out by unscrewing the nozzle body 20 from the riser 12. Many current sprinkler designs require a special tool to unclog such passageways.

In a second form, as shown in FIG. 8, the flow channel 146 may include a number of directional changes, e.g., sharp turns, so as to define a relatively tortuous flow path. The channel 146 preferably includes a pattern of grooves molded into and adjacent the nozzle body threads 38. As can be seen, the flow channel 146 includes longitudinal grooves 124 that cut across the threads 38 in a direction perpendicular to the threads 38. The flow channel 146 also includes transverse grooves 126 that extend in the same direction as the threads 38. Thus, as water flows through the flow channel 146, it experiences several right angle, or 90°, directional changes. Because of the relatively tortuous nature of this embodiment, water flowing to the secondary outlet 16 experiences a relatively high degree of energy and velocity dissipation. By adjusting the flow channel 46 in this manner, much of the water may be distributed even closer to the nozzle 10 than is distributed using the unidirectional channel 46 shown in FIG. 7.

The cross-sectional size of the flow channel 46 and 146 and/or the number of directional changes may be modified, as desired, for different nozzle models to tailor the close-in water distribution characteristics. First, the amount of water supplied to the secondary outlet 16 can be controlled by modifying the size of the channel 46 and 146 by adjusting the depth and number of the mating threads 42 of the riser 12. Deeper mating threads 42 will reduce the amount of water supplied to the secondary outlet 16, as will an increase in the number of mating threads 42. Second, the number of directional changes may be adapted to achieve a desired pressure drop. One significant advantage of this design is that the greater the number of orifices in series and/or number of directional changes, the larger the cross-sectional diameter the openings can be for the purpose of increasing tolerance for grit.

During operation of the nozzle 10, water flows in accordance with two flow paths. In one flow path, water flows from a pressurized water source to the riser 12, through the central bore 156 of the throttling screw seat 21, through the interior of the lower portion 32 of the nozzle body 20, through the deflector post groove 94, and through the primary outlet 14. Water flowing along this first flow path retains much of its energy and velocity so that it is distributed to terrain relatively far from the nozzle 10. In the second flow path, water flows from the water source, upwardly through the riser 12, upwardly through the bore 156 of the throttling screw seat 21, downwardly through the axial notches 166 into the collection groove 168, through the radial notch 106, upwardly along the flow channel 46 (FIG. 7) and 146 (FIG. 8) formed among the threads 38, and through the secondary outlet 16. Water flowing along this second flow path loses much of its energy and velocity so that it is distributed relatively close to the nozzle 10. The path and/or size of the flow channel 46 and 146 may be modified for different nozzle models, resulting in a greater or lesser water distribution immediately next to the nozzle 10.

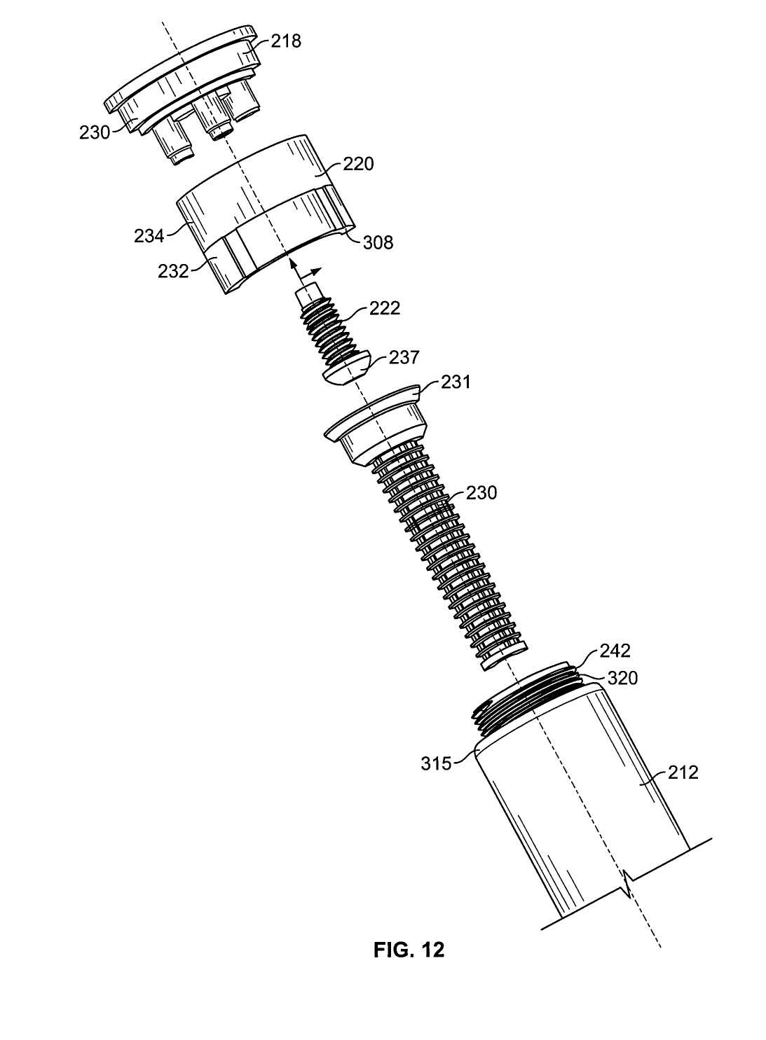

An alternate preferred embodiment of the nozzle 210 is shown in FIGS. 11 and 12. The operation of the nozzle 210 is similar to that described above. Nozzle 210 is mounted on a riser 212 and has a primary outlet 214 and a secondary outlet 216. Unlike the embodiments described above, however, nozzle 210 has internal, or female, threads 238 located on the interior portion 239 of a nozzle body 220 for threaded engagement to a riser 212 having external, or male, threads 242. In addition, unlike the embodiments described above, the direction of flow of water in the flow channel 246 of the nozzle body 220 is downwardly and away from the deflector 218. The components and operation of nozzle 210 are described in greater detail below.

As shown in FIGS. 11 and 12, the nozzle 210 preferably includes a deflector 218 and a nozzle body 220. The deflector 218 is generally the same as described above and as shown in FIGS. 3-6. The deflector 218 preferably includes the same general features as described above and may be any of various configurations for distributing water in 90°, 180°, 270°, 360°, or other predetermined arcs.

Also, in one form, as shown in FIGS. 11 and 12, the nozzle 210 may include a filter 230 having a lip 231 for engagement with an interior portion of the nozzle body 220. The inner portion 233 of the filter 230 is generally cylindrical to act as a seat for the throttling screw 222 when the screw 222 is fully advanced toward the filter 230 to reduce the throw distance of the nozzle 210 to a shut-off condition. Incorporation of the seat into the inner portion 233 of the filter 230 results in the use of a filter 230 having a relatively small diameter (such as compared to filter 30 described above).

An alternative preferred form of a filter 330 for use with nozzle 210 is shown in FIG. 16. The inner portion 333 of the filter 330 generally defines an annular cross-section. The inner portion 333 preferably includes three V-shaped grooves 335 that are spaced circumferentially about the top surface 339 of the filter 330. The top surface 339 also preferably includes a V-shaped notch 340. As the head 237 approaches the top surface 339 defined by the inner portion 333 of the filter 330, the V-shaped grooves 335 and notch 340 allow fluid flow therethrough when the head 237 is in close proximity to the filter 330. Thus, the V-shaped grooves 335 and notch 340 allow for a gradual decrease in fluid flow, and a slow shut-off of nozzle 210, as screw 222 is advanced toward filter 330.

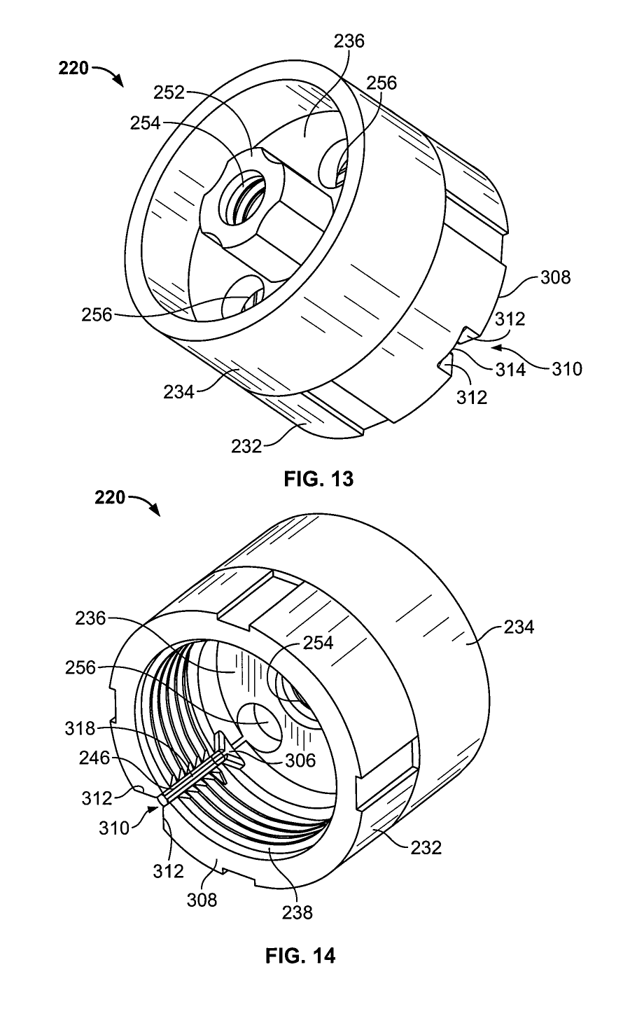

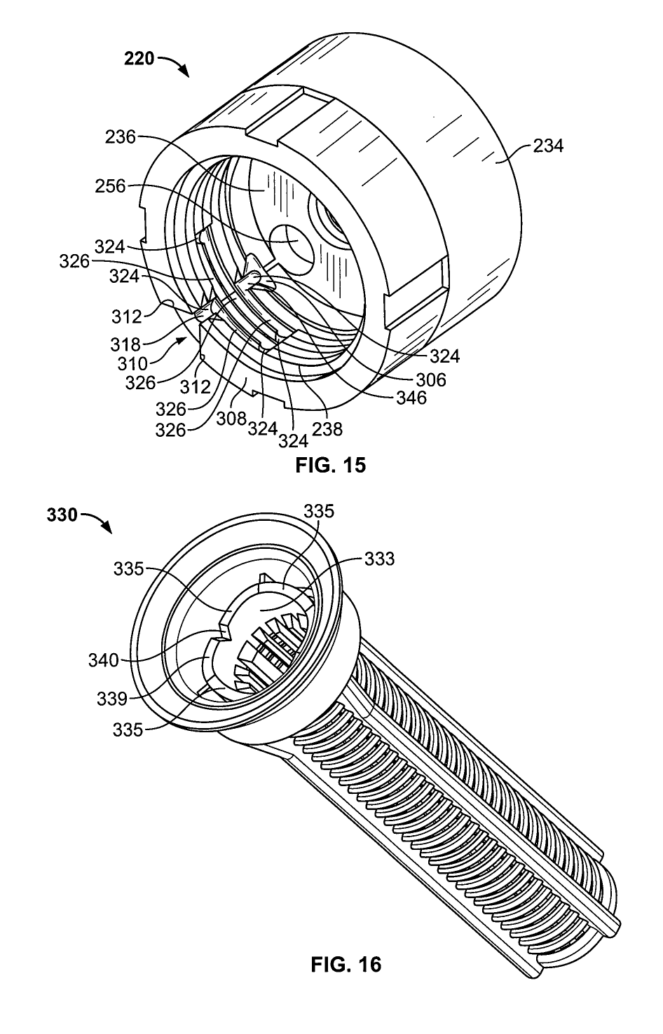

As shown in FIGS. 13-15, the nozzle body 220 of nozzle 210 is structurally different than that described above in connection with the previous embodiments. The nozzle body 220 includes a lower hollow cylindrical portion 232 and an upper hollow cylindrical portion 234 that are connected by a center plate 236. In contrast to the above embodiments, however, the lower nozzle body portion 232 has threads 238 located on the interior circumferential surface of the lower portion 232. These internal threads 238 are adapted for threaded engagement with corresponding external threads 242 of the riser 212. Thus, the threading of the nozzle body 220 and the riser 212 are the opposite of the threading in the previously-described embodiments. The internal threads 238 of the nozzle body 220 also define a flow channel 246 (FIG. 14) and 346 (FIG. 15) therethrough, as described further below.

The upper portion 234 projects upwardly from the center plate 236. The upper portion 234 preferably has the same diameter as the lower cylindrical portion 232, the center plate 236, and the wall portion 280 of the deflector 218. Thus, when the deflector 218 is mounted to and overlies the nozzle body 220, the two components form an elongated cylindrical body having a uniform diameter.

The center plate 236 preferably has four apertures 256 for the insertion of a like number of deflector posts therethrough. The apertures 256 are preferably spaced equidistantly about the center plate 236. In addition, a nozzle body hub 252 projects upwardly from the center plate 236 and defines a central bore 254 for the insertion of the throttling screw 222 through the center plate 236.

As shown in FIGS. 11 and 13-15, the nozzle body 220 includes a flow channel 246 and 346 to a secondary outlet 216 for water distribution to areas relatively close to the nozzle 210. In contrast to the above embodiments, the flow channel 246 and 346 is located in the threading 238 on the interior circumferential surface 239 of the nozzle body 220. The entrance to the flow channel 246 and 346 is preferably a fan-shaped notch 306 located above the internal threading 238, just below the center plate 236. The flow channel 246 and 346 extends downwardly away from the deflector 218 and through the internal threads 238 of the lower cylindrical portion 232. The flow channel 246 and 346 terminates in a wedge-shaped recess 310 formed in the bottom edge 308 of the lower cylindrical portion 232. The wedge-shaped recess 310 has sidewalls 312 and a top wall 314. Thus, unlike the previously-described embodiments, water flows downwardly through the flow channel 246 and 346 and away from the center plate 236. Other shapes for the notch 306 and the recess 310 may be used.

The secondary outlet 216 is completed when the nozzle body 220 is mounted to the riser 212. More specifically, the wedge-shaped recess 310 combines with a shoulder 315 of the riser 212 when the nozzle body 220 threadedly engages the riser 212. The shoulder 315 of the riser 212 provides the bottom of the secondary outlet 216. The primary and secondary outlets 214 and 216 are preferably positioned so that they cover the same arcuate segment of terrain.

The path of the flow channel 246 and 346 among the internal threads 238 may be designed in the same manner as described above. For example, as shown in FIG. 14, the flow channel 246 may cut perpendicularly across the internal threads 238 in a unidirectional downward line from the notch 306 to the recess 310. The flow channel 246 is made of a series of orifice openings having alternating cross-sectional diameters defined by the distance between the wall 318 of the flow channel 246 and the alternating riser threads 242 and grooves 320. Alternatively, as shown in FIG. 15, the flow channel 346 may zigzag among the threads 238, i.e., the flow channel 346 may include a number of 90 degree directional changes. This flow channel 346 is relatively tortuous, resulting in a significant dissipation of energy and velocity in water flow. This tortuous flow path may be desirable in order to increase the distribution of water in the area immediately next to the nozzle 210.

During operation of the nozzle 210, water flows along a first flow path and along a second flow path. In the first flow path, as with the nozzle 10, water flows from a water source, through the interior of the lower cylindrical portion 232, through the slot 294 in deflector post 264, and through the primary outlet 214. The second flow path, however, is different from that shown and described with respect to nozzle 10. Unlike the previously-described embodiments, the nozzle 210 has a flow channel 246 and 346 with an entrance located above the threads 238 and water flows downwardly from this entrance to a recess 310, located at the bottom 308 of the nozzle body 220 and defining part of the secondary outlet 216. In the second flow path, water flows from the riser 212, through the notch 306 in the nozzle body 220 above the threads 238, downwardly along the flow channel 246 and 346 formed among the threads 238, and through the secondary outlet 216.

The flow channel may be tortuous, i.e., have a number of directional changes (FIG. 15), or may be non-tortuous, i.e., have relatively few (if any) directional changes (FIG. 14), to satisfy desired close-in water distribution characteristics. As shown in FIG. 14, the non-tortuous flow channel 246 preferably extends in a longitudinal direction cutting across the internal threads 238. In contrast, as shown in FIG. 15, the tortuous flow channel 346 preferably defines a zigzag pattern that alternates between longitudinal grooves 324 and transverse grooves 326.

In general, the pressure experienced by water being distributed from conventional nozzles having only one outlet is on the order of 30 psi. The pressure experienced by water being distributed from the secondary outlet in the preferred embodiments depends on the nature of the flow channel to the secondary outlet, i.e., tortuous or non-tortuous, and on the length and cross-sectional area of the flow channel. In the preferred embodiments described herein, the pressure at the secondary outlet is on the order of 6 psi, resulting in a reduction in pressure on the order of 80% from the entrance to the exit of the flow channel. Further, in the preferred embodiments, in order to achieve this general pressure drop, the length of the flow channel ranges from about 0.2 inches (non-tortuous flow channel) to about 0.7 inches (tortuous flow channel). In addition, as described above, the riser threads and grooves create a series of alternating orifice openings for portions of the flow channel that cut perpendicularly through the threads. The cross-sectional area of these orifice openings preferably alternates between about 0.0002 square inches (relatively constricted orifice openings) and 0.001 square inches (relatively non-constricted orifice openings).

The foregoing relates to preferred exemplary embodiments of the invention. It is understood that other embodiments and variants are possible which lie within the spirit and scope of the invention as set forth in the following claims.

What is claimed is:

1. A spray head nozzle comprising:
a deflector having an underside surface with a first recess formed therein;
a nozzle body having an upper surface for engaging at least a portion of the underside surface of the deflector and for cooperating with the first recess to form a primary outlet for distributing fluid radially outwardly from the deflector through a first arcuate span, having a threaded portion for coupling to a source of pressurized fluid, the threaded portion defining a flow channel through the threads, and having a second recess formed in the nozzle body and defining at least in part a secondary outlet for distributing fluid radially outwardly from the nozzle body through a second arcuate span;
a first fluid flow path through, at least in part, the interior of the nozzle body to the primary outlet; and
a second fluid flow path through, at least in part, the flow channel to the secondary outlet.

2. The spray head nozzle of claim 1 wherein the flow channel comprises a groove extending generally perpendicularly across the threads of the threaded portion of the nozzle body.

3. The spray head nozzle of claim 1 wherein the flow channel comprises a series of grooves including at least one extending generally perpendicularly through the threads and at least one extending generally in the direction of the threads.

4. The spray head nozzle of claim 1 wherein the flow channel includes a wall formed in the threaded portion, the wall defining at least in part a series of orifices when the threaded portion engages a corresponding threaded portion at the fluid source.

5. The spray head nozzle of claim 4 wherein the series of orifices comprises a first set of orifices and a second set of orifices, and the first set of orifices having a smaller cross-sectional area than the second set of orifices.

6. The spray head of claim 1 wherein the second recess is adapted to form, in part, the secondary outlet when the nozzle body is threadedly mounted to the fluid source.

7. The spray head nozzle of claim 1 wherein the nozzle body further comprises a plate connected to the threaded portion, the plate disposed between the threaded portion and the underside surface of the deflector.

8. The spray head nozzle of claim 7 wherein the nozzle body further defines a notch to place the flow channel in fluid communication with the fluid source and wherein the plate defines the second recess.

9. The spray head nozzle of claim 8 wherein fluid flowing in the second flow path flows through the notch, along the flow channel and in the direction of the deflector, and through the secondary outlet.

10. The spray head nozzle of claim 7 wherein the nozzle body further comprises a third recess formed in the plate to allow fluid to enter the flow channel.

11. The spray head nozzle of claim 10 wherein fluid flowing in the second flow path flows through the third recess, along the flow channel and away from the deflector, and through the secondary outlet.

12. The spray head nozzle of claim 7 wherein the nozzle body further comprises a first hollow cylindrical member for mounting to the underside surface of the deflector and wherein the threaded portion defines a second hollow cylindrical member, the first and second members generally transition at the nozzle body plate.

13. The spray head nozzle of claim 7 wherein the plate defines one or more apertures therethrough.

14. The spray head nozzle of claim 13 wherein the deflector has one or more posts projecting from the underside surface of the deflector and adapted for insertion through the one or more apertures.

15. The spray head nozzle of claim 14 wherein one or more of the posts has a slot extending along its length defining a flow passage in fluid communication with the first recess.

16. The spray head of claim 15 wherein the first recess and the cross-section of the slot are sized to distribute fluid at a predetermined precipitation rate.

17. The spray head nozzle of claim 1 wherein the nozzle body and deflector each have a central bore extending therethrough, the central bores defining a concentric relationship with one another when the nozzle body and the deflector are assembled together.

18. The spray head nozzle of claim 17 further comprising a member extending through the central bores of the nozzle body and deflector for adjustably throttling fluid flow through the spray head nozzle.

19. The spray head nozzle of claim 18 further comprising a seat portion adapted to cooperate with the member, the seat portion including a plurality of notches defining a portion of the second fluid flow path.

20. The spray head nozzle of claim 1 wherein the second arcuate span is substantially the same as the first arcuate span.

21. The spray head nozzle of claim 1 wherein the first and second recesses are generally wedge-shaped for arcuate distribution of fluid.

22. A method for distributing fluid from a spray head nozzle comprising:
providing a spray head nozzle having a primary outlet for distant fluid distribution, a secondary outlet for close-in fluid distribution, a threaded portion having threads for coupling to a source of pressurized fluid, and a first fluid flow path through the nozzle to the primary outlet;
molding one or more grooves through the threads of the threaded portion to define a flow channel to the secondary outlet, the flow channel forming part of a second fluid flow path to the secondary outlet;
coupling the spray head nozzle to a source of pressurized fluid; and
providing pressurized fluid to the spray head nozzle for distribution from the primary and secondary outlets.

23. The method of claim 22 wherein the flow channel comprises at least one groove extending generally perpendicularly through the threads.

24. The method of claim 22 wherein the flow channel comprises a series of grooves including at least one extending generally perpendicularly through the threads and at least one extending generally in the direction of the threads.
